(19) United States
(12) Patent Application Publication
(10) Pub. No.: US 2008/0172466 A1
(43) Pub. Date: Jul. 17, 2008

(54) E-mail delivery device, contact point guiding device, and e-mail delivery method and program

(75) Inventors: Satoko Tonegawa, Yamato-shi (JP); Nobuhiro Asai, Setagaya-ku (JP)

Correspondence Address: SYNNESTVEDT & LECHNER, LLP, 1101 MARKET STREET, SUITE 2600, PHILADELPHIA, PA, 19107-2950, US

(73) Assignee: International Business Machines Corporation, Armonk, NY (US)

(21) Appl. No.: 10/742,085

(22) Filed: Dec. 19, 2003

(30) Foreign Application Priority Data
Feb. 20, 2003 (JP) 2003-042585

(51) Int. Cl. G06F 15/16

(52) U.S. Cl. 709/206; 709/203

(57) ABSTRACT

It is an object of the present invention to send information accurately to a target person having a plurality of e-mail addresses or contact points. A delivery server 10 is provided for sending an e-mail selectively to a target person having a plurality of e-mail addresses. The delivery server 10 predicts a target person's condition when sending the e-mail, orders the plurality of e-mail addresses in descending order of likelihood that the target person will receive the e-mail, and sends the e-mail according to the ordering. Furthermore, it is configured so that the next ordering reflects the e-mail address where the target person has received the message as a result of sending the e-mail.

### FIELD OF THE INVENTION

The invention relates to a method for communicating information to a target person using e-mail and the like, more particularly, to a method for communicating information more accurately to a target person having a plurality of contacts (e.g. mail addresses).

### BACKGROUND ART

In recent years, it has become commonplace for individuals to have a wide variety of ways of receiving information. As an example, a person can possess one email address for use on his/her office PC (personal computer), another for use on his/her home PC, and yet another for use on his/her mobile telephone or PDA. The more information receiving terminals a person possesses, the greater the number of available email addresses he/she is likely to have.

In such situations, an information originator (contacting person) is required to be accurate when sending information to an information receiver (a delivery target person). For example, if the contacting person sends an e-mail to an e-mail address that is set for the target person's home PC, the target person cannot receive the e-mail immediately if he/she is away from home at that time. If the information originator instead sends information to all e-mail addresses possessed by the target person, the target person will likely receive the e-mail promptly, but this also leads to an increased amount of unnecessary information traffic.

For sending an e-mail to a delivery target person having a plurality of mail addresses, a technique described in Japanese Published Unexamined Patent Application No. 2002-26961 (pp. 11, FIG. 9) has been proposed. The application discloses a technique whereby a destination e-mail address is deleted if it has not been used for a predetermined time period.

However, even if e-mail addresses that have not been used for a predetermined period are deleted, it is difficult to fundamentally solve the problem of increasing information traffic. Although Japanese Published Unexamined Patent Application No. 2002-26961 (pp. 11, FIG. 9) describes a technique for selecting an e-mail address of a target person based on information on the current location of the contacting person and information on that of the target person, the technique has the problem that if there is some mistake in the current location of the target person, information can not be communicated to the target person.

The present invention has been made to solve the technical challenges mentioned above, and has an object of communicating information accurately to a target person having a plurality of mail addresses and contacts.

Another object of the invention is to communicate information accurately to a target person with increased control of information traffic.

Yet another object of the invention is to communicate information accurately to a target person when there is little information that indicates the current situation of the target person, such as his/her current location, that can be obtained from the target person.

### SUMMARY OF THE INVENTION

The present invention comprises sending an e-mail to a delivery target person having a plurality of e-mail addresses in descending order of likelihood that the target person will receive the e-mail. The invention also proposes that the order in which an e-mail is sent on the next occurrence reflects the result of sending e-mails previously, that is, it is sent first to an e-mail address at which the delivery target person has successfully received e-mails.

That is, according to the present invention, an e-mail delivery device for sending an e-mail to a target person having a plurality of e-mail addresses comprises storage means for storing a condition of the target person associated with the e-mail addresses; prediction means for predicting, i.e., determining, the target person's likely condition when sending the e-mail to the target person; ordering means for fetching a given number of e-mail addresses from the storage means and ordering the given number of fetched e-mail addresses on the basis of the predicted likely condition; and delivery means for sending an e-mail sequentially by using the given number of ordered e-mail addresses.

The prediction means obtains the target person's schedule and determines their likely condition on the basis of the obtained schedule. The e-mail delivery device further comprises receiving means for receiving a receipt confirmation returned from a predetermined e-mail address in response to the e-mail sent by the delivery means, wherein the delivery means stops sending an e-mail when a receipt confirmation has been received. The e-mail delivery device further comprises receiving means for receiving receipt confirmations returned from predetermined mail addresses in response to the e-mail sent by the delivery means, wherein the ordering means modifies the order of the predetermined e-mail addresses in the next ordering. Further, the ordering means fetches a mail address from the storage means that matches a condition predicted by the prediction means.

According to another aspect of the invention, an e-mail delivery device for sending an e-mail to a target person having a plurality of e-mail addresses comprises storage means for storing records of delivery requirements of the target person associated with e-mail addresses at which the target person requires that e-mail be received; condition acquisition means for acquiring a personal condition in which the target person is supposed to be put in when sending the e-mail to the target person; delivery list generation means for acquiring records matching the condition acquired by the condition acquisition means from the storage means and generating a delivery requirement list; theoretical value generation means for generating a theoretical value related to ease of arrival of the e-mail at the target person; delivery priority list generation means for generating a delivery priority list by ordering the e-mail addresses in the delivery requirement list generated by the delivery list generation means on the basis of the theoretical value generated by the theoretical value generation means; and delivery means for sending the e-mail to the e-mail addresses in the order of descending priorities thereof on the basis of the delivery priority list generated by the delivery priority list generation means.

The e-mail delivery device further comprises receiving means for receiving a receipt confirmation for the e-mail sent by the delivery means, wherein the theoretical value generation means modifies a theoretical value on the basis of the receipt confirmation received by the receiving means. The e-mail delivery device further comprises count storage means for storing delivery requirements associated with the number of attempts to send e-mails by the delivery means and the number of times receipt confirmation have been received by the receiving means, and expected value generation means for generating an expected value corresponding to each delivery requirement on the basis of a count value stored in the count storage means, wherein the theoretical value generation means can modify theoretical values on the basis of expected values generated by the expected value generation means. The e-mail delivery device further comprises initial priority storage means for storing a list of priorities of delivery requirements preset by a target person, wherein the theoretical value generation means determines the initial theoretical values on the basis of the initial priority list obtained from the initial priority storage means.

The invention can also be viewed as a contact point guiding device in addition to the e-mail delivery device mentioned above.

That is, according to the invention, a contact point guiding device for guiding a contacting person to a contact point when contacting a target person having a plurality of contact points comprises acquisition means for acquiring correspondence between a target person's condition and the contact points; prediction means for predicting the condition of the target person when contacting the target person; and ordering means for acquiring a given number of contact points by using the acquisition means and ordering the given number of acquired contact points on the basis of the predicted condition.

In the contact point guiding device, a contact point acquired by the acquisition means comprises at least one of an e-mail address, telephone number, and a facsimile number. In addition, the ordering means can make next ordering that reflects the result of contact performed in accordance with an ordering.

The invention can be also viewed as a program for enabling a computer to send an e-mail from a storage device storing a plurality of mail addresses for a given target person to a specific mail address for achieving the functions of: predicting a target person's condition when sending the e-mail to the target person; fetching the plurality of e-mail addresses from the storage device and ordering the plurality of e-mail addresses on the basis of the predicted condition; and sending the e-mail sequentially on the basis of the ordering.

Such a program to be executed on a computer may be provided as stored on a computer readable storage medium. Such a storage medium includes CD-ROM and the like, and the program may be read by a CD-ROM drive in a computer, stored in various types of memory such as hard disk in the computer to be executed thereon. Alternatively, the program may be provided to a notebook PC or mobile terminal over a network via a program transmission device. The program transmission device should be equipped with at least memory for storing the program and program transmission means for providing the program over a network.

The invention may also be viewed as a method invention that expresses respective functions of the program invention mentioned above as steps.

### BRIEF DESCRIPTION OF THE DRAWINGS

FIG. 1 is a block diagram illustrating the overview of an e-mail delivery system of an embodiment;

FIG. 2 schematically shows an example of the hardware configuration of a computer suitable for realizing a delivery server;

FIG. 3 is a block diagram illustrating functions of the delivery server;

FIG. 4 is a block diagram illustrating the mail sending/receiving functions of a PDA;

FIG. 5 is a flowchart showing the process of inputting records and a priority list by a delivery target person;

FIG. 6 is a flowchart showing the fundamental flow of e-mail delivery;

FIG. 7 is a flowchart showing the fundamental flow of the e-mail delivery (continued from FIG. 6); and

FIG. 8 is a graph showing the relationship between the number of attempts to send e-mails (number of times) and scores that are obtained through a simulation.

### DETAILED DESCRIPTION OF THE PREFERRED EMBODIMENTS

In the following, embodiments of the invention will be described in detail with reference to accompanying drawings.

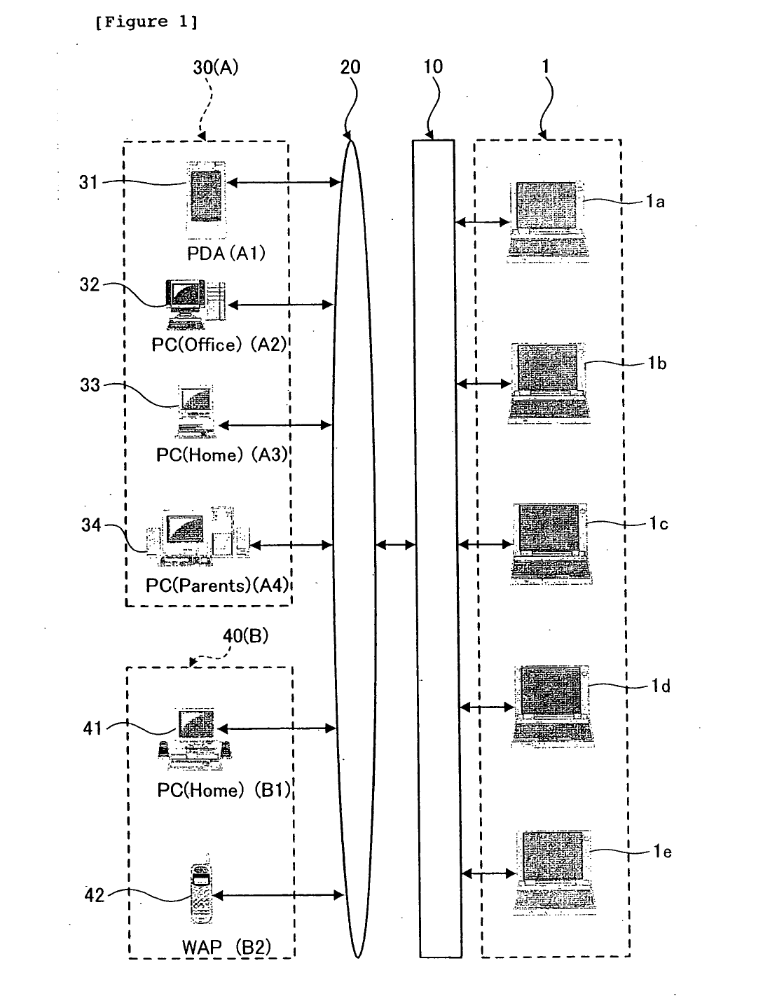

FIG. 1 shows a block diagram illustrating the overview of an e-mail delivery system according to an embodiment of the invention. The e-mail delivery system has an e-mail delivery terminal group 1 consisting of a plurality of e-mail delivery terminals 1a to 1e, a delivery server 10 as an e-mail delivery device that is connected to the e-mail delivery terminal group 1, and a first e-mail receiving terminal group 30 and a second e-mail receiving terminal group 40 that are connected to the delivery server 10 via the Internet 20 as a communication network. The first e-mail receiving terminal group 30 are a plurality of e-mail receiving terminals that can be possessed or used by a target person A registered with the delivery server 10, including, in the example, a portable PDA 31, a PC installed in the target person's office (hereinafter, referred to as PC (Office)) 32, a PC installed in his/her home (hereinafter referred to as PC(Home)) 33, and a PC installed in his/her parents' house (hereinafter referred to as PC(Parents)) 34. For these PDA 31, PC (Office) 32, PC (Home) 33, and PC (Parents) 34, mail addresses A1, A2, A3 and A4 for the target person A are set, respectively. The second e-mail receiving terminal group 40 are a plurality of e-mail receiving terminals that can be possessed or used by a delivery target person B registered with the delivery server 10, including PC (Home) 41 that is installed in his/her house and a portable WAP (Wireless Application Protocol Phone, referred to as WAP herein) 42 in this example. Mail addresses B1 and B2 for the target person B are set for the PC (Home) 41 and WAP 42 constituting the second e-mail receiving terminal group 40, respectively.

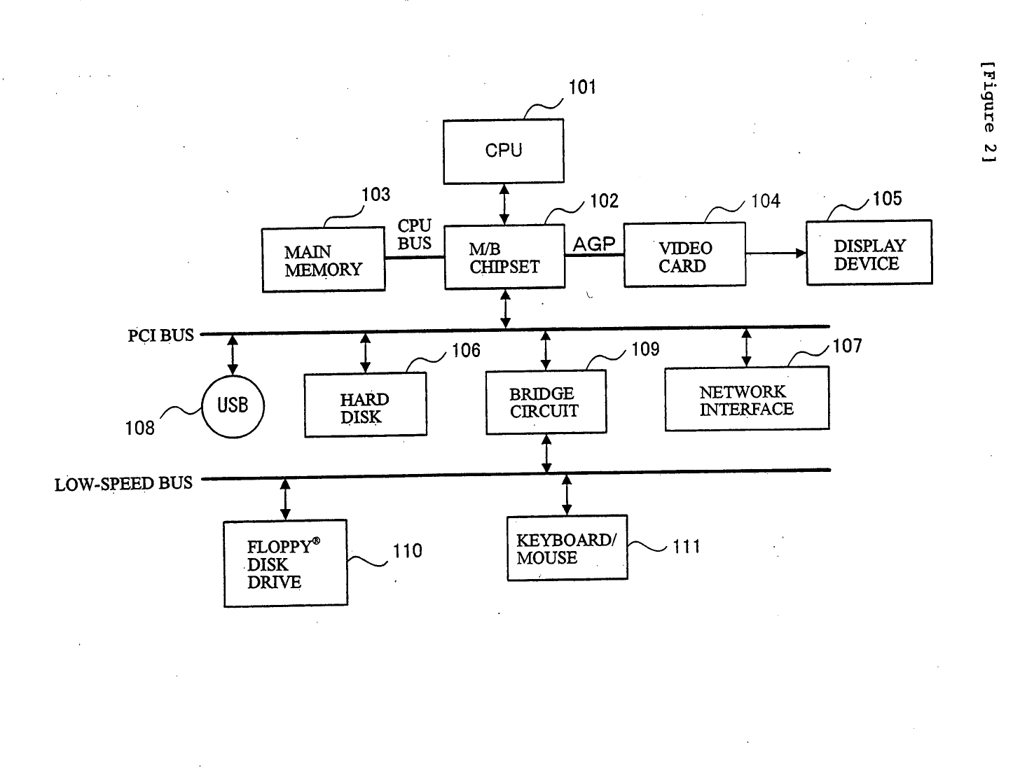

FIG. 2 schematically shows an example of the hardware configuration of a computer preferred for realizing the delivery server 10 in the embodiment.

The computer shown in FIG. 2 comprises a CPU (Central Processing Unit) 101 as operating means, main memory 103 that is connected to the CPU 101 through M/B (motherboard) chipset 102 and a CPU bus, a video card 104 connected to the CPU 101 also through the M/B chipset 102 and an AGP (Accelerated Graphics Card), a display device 105 connected via the video card 104, a hard disk 106 that is connected to the M/B chipset 102 via a PCI (Peripheral Component Interconnect) bus, a network interface 107 and a USB port 108, and a floppy disk drive 110 and a keyboard/mouse 111 that are connected to the n/B chipset 102 via a low-speed bus such as an ISA (Industry Standard Architecture) bus through a bridge circuit 109 and via the PCI bus.

FIG. 2 merely shows an example of one hardware configuration of the computer for realizing the described embodiment, and a variety of other configurations of this embodiment are possible. For example, instead of providing the video card 104, only video memory may be mounted and the CPU 101 may process image data, or CD-ROM (Compact Disk Read Only Memory) and DVD-ROM (Digital Versatile Disc Read Only Memory) drives may be provided via an interface such as ATA (AT Attachment).

For the e-mail delivery terminal group 1, the first e-mail receiving terminal group 30 and the second e-mail receiving terminal group 40 as well, terminals having the hardware configuration of the computer in FIG. 2 may be employed. However, these e-mail delivery terminal group 1, the first e-mail receiving terminal group 30 and the second e-mail receiving terminal group 40 only need to have at least capability of sending/receiving e-mails as described later and may have a simpler configuration.

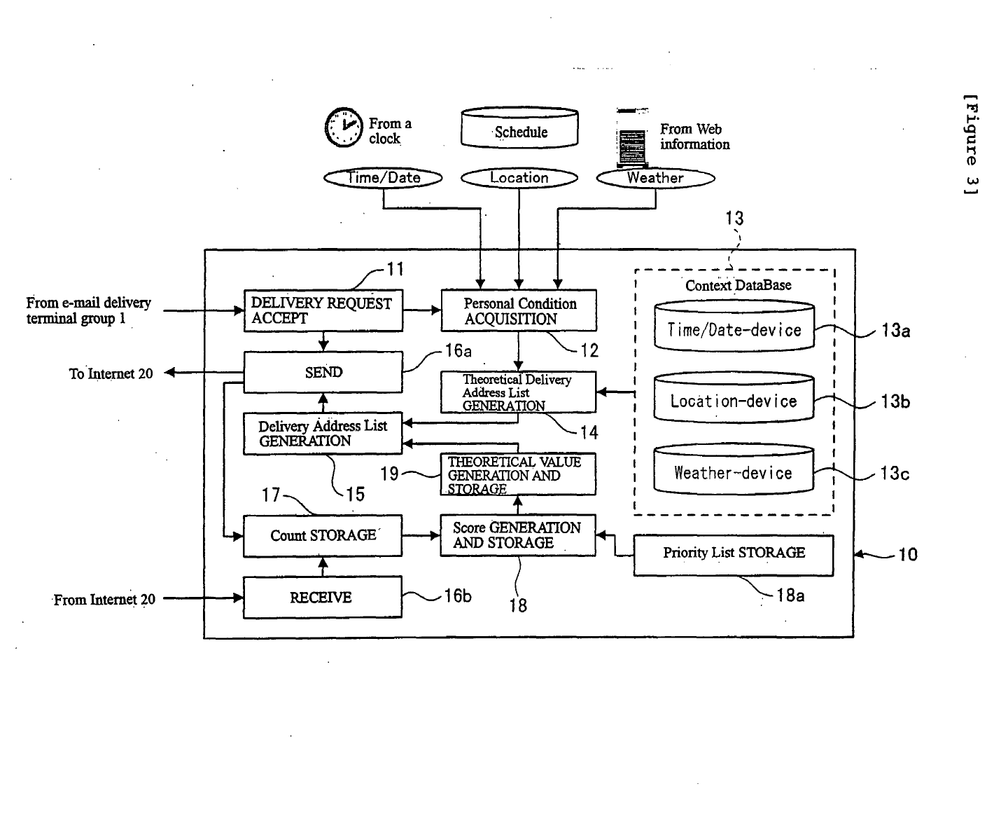

FIG. 3 is a block diagram illustrating functions of the delivery server 10. The delivery server 10 comprises a delivery request accepting portion 11, a personal condition acquisition portion 12 as condition acquisition means or prediction means, a context database portion 13 as storage means, a theoretical delivery address list generation portion 14 as delivery list generation means, a delivery address list generation portion 15 as priority list generation means, a delivery portion 16a as delivery means, a receiving portion 16b as receiving means, a count storage portion 17 as theoretical point generation means, a score generation and storage portion 18, and a theoretical point generation and storage portion 19. A priority list storage portion 18a is connected to the score generation and storage portion 18. The theoretical delivery address list generation portion 14 and the delivery address list generation portion 15 function as ordering means.

The delivery request accepting portion 11 accepts a request for sending an e-mail from the e-mail delivery terminal group 1 (see FIG. 1) and passes the accepted request for sending the e-mail to the delivery portion 16a. The personal condition acquisition portion 12 acquires personal condition in which a target person (A or B in this example) to whom the e-mail accepted in the delivery request accepting portion 11 should be sent is expected to be in currently. Specifically, it obtains the current time/date from a clock, a location where the target person schedules to stay from the target person's schedule that is stored in a storage device (not shown), and weather in that location from Web information. The clock may be one contained internally in the delivery server 10 or one that is provided externally. And the target person's schedule is registered in advance by the person. Note that personal conditions to be obtained are not actual conditions that the target person is presently placed in, but are conditions that are predicted based on information registered in advance. The personal condition acquisition portion 12 thus has capability of presuming the target person's situation. The context database portion 13 stores records (data associating delivery requirements with desired mail receiving terminals to which he/she wants e-mails to be sent) that are registered in advance by the target person. Describing this more specifically, the context database portion 13 comprises a time/date-device storage portion 13a for storing times/dates and e-mail receiving terminals (devices) to which e-mails should be sent as associated with each other, a location-device storage portion 13b for storing locations of the target person and e-mail receiving terminals to which e-mails should be sent as associated with each other, and weather-device storage portion 13c for storing weather information for the location of the target person and e-mail receiving terminals to which an e-mail should be sent as associated with each other. The context database portion 13 also stores mail addresses each corresponding to each of the e-mail receiving terminals as associated with each other.

The theoretical delivery address list generation portion 14 reads delivery requirements matching the target person's personal situation which has been acquired by the personal condition acquisition portion 12 and a record corresponding to the requirement from the context database portion 13, and generates a theoretical delivery address list. Based on the theoretical delivery address list generated by the theoretical delivery address list generation portion 14, the delivery address list generation portion 15 weighs terminals (addresses) in consideration of a theoretical point for the delivery requirement that is obtained from the theoretical point generation and storage portion 19, which will be mentioned later, and generates a delivery address list which orders e-mail receiving terminals (mail addresses) in descending order of likelihood that the e-mail will reach the target person.

Based on the delivery address list generated by the delivery address list generation portion 15, the delivery portion 16a sets a destination mail address from the top of the list sequentially and sends the e-mail which was requested to be sent by the e-mail delivery terminal group 1 (FIG. 1) over the Internet 20. A specific procedure of sending an e-mail will be described later. The receiving portion 16b receives a confirmation mail which is returned from the target person by he/she confirming the e-mail sent from the delivery portion 16a. The count storage portion 17 counts and stores the number of times e-mails have been sent from the delivery portion 16a and the number of times the receiving portion 16b have received confirmation mails for each delivery requirement. The score generation and storage portion 18 generates and stores a expected value (hereinafter referred to as “score” as necessary) based on a theoretical point for a delivery requirement stored in the theoretical point generation and storage portion 19 and a count value stored in the count storage portion 17. The theoretical point generation and storage portion 19 generates and stores a theoretical point for a delivery requirement based on a score generated by the score generation and storage portion 18. The priority list storage portion 18a stores a priority list for the delivery requirements. The priority list is registered beforehand by a target person. The personal condition acquisition portion 12, context database portion 13, theoretical delivery address list generation portion 14, delivery address list generation portion 15, count storage portion 17, score generation and storage portion 18, priority list storage portion 18a, and theoretical point generation and storage portion 19 are software blocks that are realized by the CPU 101 in FIG. 2 controlled by a program, and the program for controlling the CPU 101 to realize these functions is provided as stored and distributed on a magnetic disk or optical disk, semiconductor memory, and other storage media, or delivered over a network, and loaded to the main memory 103. The delivery request accepting portion 11, delivery portion 11a and receiving portion 16b are realized through the network interface 107. Data or programs maintained in the main memory 103 can be saved in a storage device such as the hard disk 106 as required.

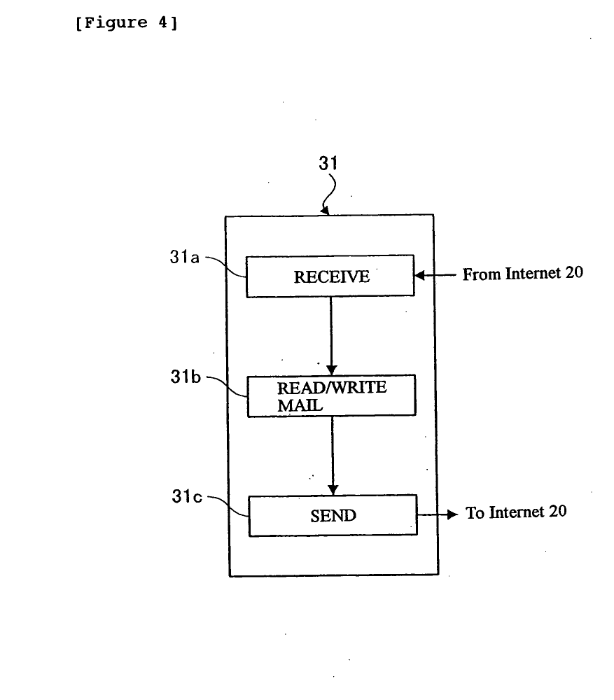

FIG. 4 is a block diagram illustrating the mail sending/receiving function of the PDA 31. The PDA 31 has a receiving portion 31a for receiving e-mails via the Internet 20, mail reading/writing portion 31b capable of viewing e-mails received by the receiving portion 31a and also composing an e-mail, and a delivery portion 31c for sending the e-mail generated by the mail reading/writing portion 31b via the Internet 20. In addition to PDA 31, the PC (Office) 32, PC (Home) 33 and PC (Parents) 34 that constitute the first e-mail receiving terminal group 30, or the PC (Home) 41 and WAP 42 that constitute the second e-mail receiving terminal group 40 have configurations similar to PDA 31. In addition, the e-mail delivery terminals 1a to 1e that constitute the e-mail delivery terminal group 1 have similar configurations.

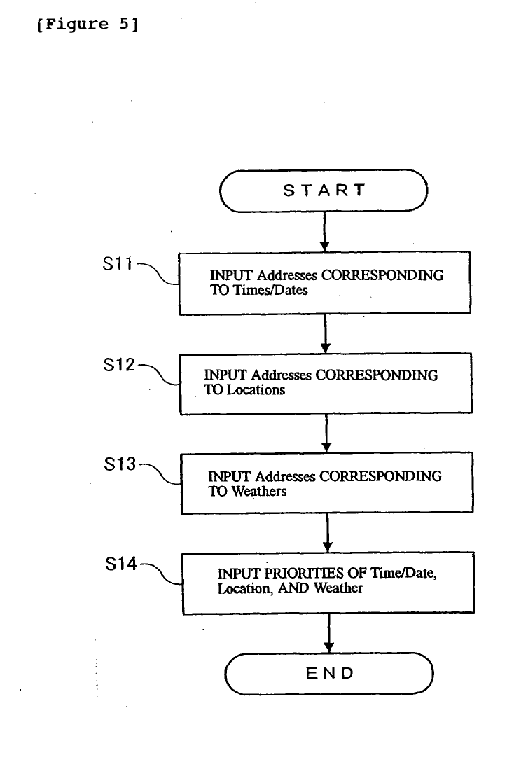

FIG. 5 shows a flowchart that illustrates the process for a delivery target person to enter his/her records and priority list in the e-mail delivery system of the embodiment.

The delivery target person first inputs mail addresses corresponding to time/date (step 11). Specifically, the person inputs e-mail receiving terminals (devices) and their e-mail addresses to which he/she wants e-mails to be sent in each of multiple time periods (morning, daytime and evening, for example) in a day. Inputted records relating to time are stored in the time/date-device storage portion 13a of the context database portion 13. Then, the delivery target person inputs mail addresses corresponding to locations (step 12). Specifically, he/she designates a number of locations (e.g. home, office, away from home) and inputs e-mail receiving terminals (devices) and their mail addresses to which he/she wants e-mails to be sent when he/she is at those locations. Inputted records about locations are stored in the location-device storing portion 13b of the context database portion 13. The delivery target person further inputs mail addresses corresponding to weather conditions (step 13). Specifically, he/she designates a number of weather conditions (fine, cloudy, rainy and the like) and inputs e-mail receiving terminals (devices) and their mail addresses to which he/she wants e-mails to be sent in those weather conditions. Inputted records on weather conditions are stored in the weather-device storing portion 13c of the context database portion 13. Finally, he/she inputs the priorities of the time/date, location and weather (step 14). That is, the person ranks those delivery requirements (time/date, location, and weather) in terms of their priorities. Inputted priority list is stored in the priority list storage portion 18a. The delivery requirements and the priority list are stored in the context database portion 13 and priority list storage portion 18a respectively for each delivery target person (in this example, A and B).

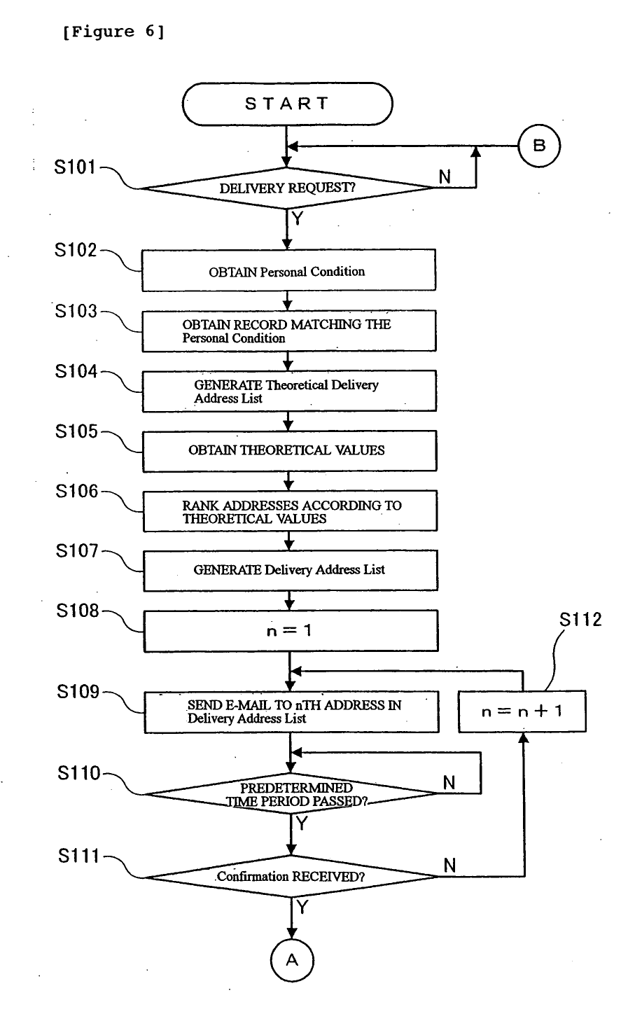

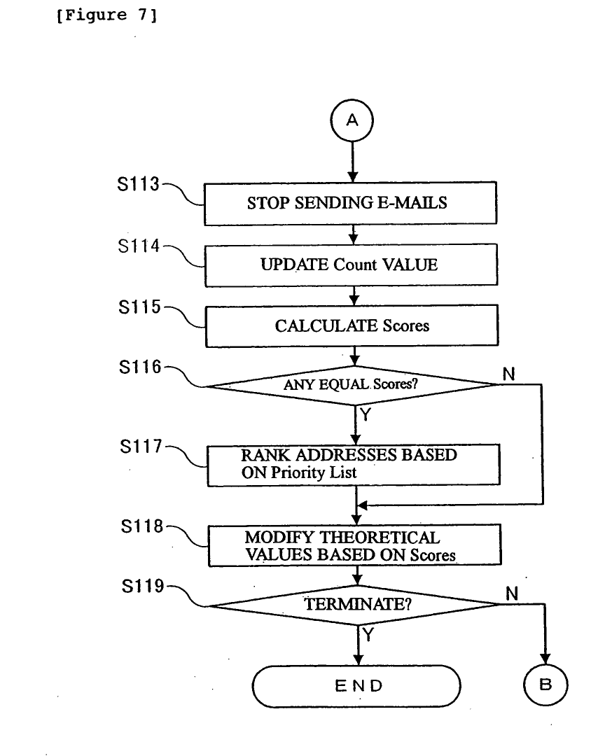

FIGS. 6 and 7 show a flowchart illustrating the basic flow of e-mail delivery in this embodiment. In the following, the e-mail delivery of the embodiment will be described with reference to FIGS. 6 and 7.

The process is initiated upon the delivery request accept portion 11 accepting a request for sending an e-mail from the e-mail delivery terminal group 1 (step 101). When a request for e-mail delivery has been received, the personal condition acquisition portion 12 determines whether the delivery target person is A or B based on the destination of the accepted e-mail and obtains the personal condition for the determined target person (step 102). In contrast, when there is no request for e-mail delivery, the process returns to step 101 and waits for a request. Then, the theoretical delivery address list generation portion 14 obtains delivery requirements that match the target person's personal condition and corresponding records from the context database stored in the context database portion 13 (step 103), and generates a theoretical delivery address list from the personal condition and record (step 104).

Then, the delivery address list generation portion 15 obtains theoretical points of the delivery requirements that have been generated and stored by the theoretical point generation and storage portion 19 (step 105), and, based on the theoretical points, orders the required delivery list obtained from the theoretical delivery address list generation portion 14 (step 106) to prepare a delivery address list (step 107). Then, the process sets n=1 (step 108), and delivery portion 16a sends the e-mail that has been accepted by the delivery request accept portion 11 to the nth (initially the first) mail address in the generated delivery address list (step 109). Then, after a predetermined period of time (step 110), it is determined whether or not a reply (confirmation) to the sent e-mail has been received by the receiving portion 16b (step 111). If a confirmation has not been received, the process sets n=n+1 (step 112) and returns to step 109. That is, an e-mail with the same content will be sent to a mail address ranked second in the delivery address list.

Meanwhile, if a confirmation has been received at step 111, mail delivery is stopped (step 113), and the count storage portion 17 updates the number of times e-mails have been sent for each delivery requirement and the number of times confirmations have been received (the number of sending e-mails and the number of receiving confirmations are collectively referred to as “count value”) (step 114) and stores them. And, based on the theoretical point of the current delivery requirement obtained from the theoretical point generation and storage portion 19 and the count value stored in the count storage portion 17, the score generation and storage portion 18 calculates a score for each delivery requirement (step 115). Next, it is determined whether or not there are any equal scores among scores for each delivery requirement that have been calculated (step 116), and, if there are equal scores, those scores are given a rank for equal score according to the priority list stored in the priority list storage portion 18a (step 117). In contrast, if there are no equal scores, then the process jumps to step 118. Then, the theoretical point generation and storage portion 19 modifies the theoretical points for each delivery requirement based on the scores obtained from the score generation and storage portion 18 and stores them (step 118). Subsequently, it is determined if the process will be terminated or not (step 119). If the process continues, the process returns to step 101, otherwise the processing is terminated.

In the following, e-mail delivery described above will be described in greater detail by referring to specific examples. The description below will address a case where an e-mail is sent from the e-mail delivery terminal 1a in FIG. 1 to the delivery target person A. It is assumed that the target person A has set his/her delivery requirement shown in Tables 1(a) to (c) and a priority list shown in Table 1(d) following the flowchart shown in FIG. 5.

TABLE 1a
(a) Time-Device

| Condition | Time | Device | Address |
|---|---|---|---|
| T1 | 22:00-07:00 | PDA | A1 |
| T2 | 07:00-18:00 | PC(Office) | A2 |
| T3 | 18:00-22:00 | PC(Home) | A3 |

TABLE 1b
(b) Location-Device

| Condition | Location | Device | Address |
|---|---|---|---|
| L1 | School | PDA | A1 |
| L2 | Parents' Home | PC(Parents' home) | A4 |
| L3 | Others | PC(Home) | A3 |

TABLE 1c
(c) Weather-Device

| Condition | Weather | Device | Address |
|---|---|---|---|
| W1 | Fine | PDA | A1 |
| W2 | Rain | PC(Office) | A2 |
| W3 | Others | PDA | A1 |

TABLE 1d
(d) Priority List

| Rank | Condition |
|---|---|
| 1 | Time/Date (I) |
| 2 | Location (L) |
| 3 | Weather (W) |

TABLE 2

| | |
|---|---|
| Time | 17:30 |
| Location | Tokyo |
| Weather | Fine |

Table 2 shows personal conditions for the delivery target person A that have been obtained at step 102 after accepting delivery of an e-mail from the e-mail delivery terminal 1a to the delivery target person A at step 101. As shown, the time is 17:30, the location the delivery target person A is supposed to stay is Tokyo, and the weather is fine.

TABLE 3

| Condition | Device | Address |
|---|---|---|
| T2 | PC (Office) | A2 |
| L3 | PC (Home) | A3 |
| W1 | PDA | A1 |

Table 3 shows a theoretical delivery address list that has been generated at step 104 based on the records obtained at step 103. In this example, a delivery requirement T2 (07:00-18:00) that corresponds with the time/date condition (17:30), a delivery requirement L3 (Others) that corresponds with location condition (Tokyo), and a delivery requirement W1 (fine) that corresponds with weather condition (fine) are selected. “Others” is selected for location because “Tokyo” is neither “school” nor “parents' home”.

TABLE 4

| (a) | | | | (b) |
|---|---|---|---|---|
| Condition | Device | Address | Theoretical Point | Priority |
| T1 | PDA | A1 | 3 | 1 |
| T2 | PC (Office) | A2 | 3 | 1 |
| T3 | PC (Home) | A3 | 3 | 1 |
| L1 | PDA | A1 | 2 | 2 |
| L2 | PC(Parents' Home) | A4 | 2 | 2 |
| L3 | PC (Home) | A3 | 2 | 2 |
| W1 | PDA | A1 | 1 | 3 |
| W2 | PC (Office) | A2 | 1 | 3 |
| W3 | PDA | A1 | 1 | 3 |

Table 4(a) shows theoretical points stored in the theoretical point generation and storage portion 19 in the initial state. In this example, based on the priority list (see Tables 1(d) and 4(b)) registered by the delivery target person A, 3 is given as a theoretical point to entries relevant to time of the highest priority, 2 to entries relevant to location of the second highest priority, and 1 to entries relevant to weather of the third highest priority, for each delivery requirement.

TABLE 5

| Condition | Device | Address | Theoretical Point |
|---|---|---|---|
| T2 | PC (Office) | A2 | 3 |
| L3 | PC (Home) | A3 | 2 |
| W1 | PDA | A1 | 1 |

TABLE 6

| | | | | Theoretical |
|---|---|---|---|---|
| List | Condition | Device | Address | Point |
| 1 | T2 | PC (Office) | A2 | 3 |
| 2 | L3 | PC (Home) | A3 | 2 |
| 3 | W1 | PDA | A1 | 1 |

Table 5 shows theoretical points that are obtained at step 105, and Table 6 shows a delivery address list that is generated at step 106 using the theoretical points obtained at step 105. In this example, a delivery address list is generated that orders the theoretical points in descending order, i.e. that ranks the delivery requirement T2 (PC (Office) 32, mail address A2) first, the delivery requirement L3 (PC (Home) 33, mail address A3) second, and the delivery requirement W1 (PDA 31, mail address A1) third.

TABLE 7

| Condition | Device | Address | Count |
|---|---|---|---|
| T1 | PDA | A1 | 0/0 |
| T2 | PC (Office) | A2 | 0/0 |
| T3 | PC (Home) | A3 | 0/0 |
| L1 | PDA | A1 | 0/0 |
| L2 | PC(Parents' Home) | A4 | 0/0 |
| L3 | PC (Home) | A3 | 0/0 |
| W1 | PDA | A1 | 0/0 |
| W2 | PC (Office) | A2 | 0/0 |
| W3 | PDA | A1 | 0/0 |

Table 7 shows count values that are stored in the count storage portion 17 in the initial state. In the table, the number to the right of a slash (/) in the count column indicates the number of attempts to send e-mails for a corresponding delivery requirement, and the number left to the slash indicates the number of confirmation mails received after sending e-mails. It means that the closer the number of attempts to send e-mails is to the number of received confirmation mails, the more likely e-mails will reach the delivery target person A. As is apparent from the table, count values are all zero in the initial state.

TABLE 8

| Condition | Device | Address | Count |
|---|---|---|---|
| T2 | PC (Office) | A2 | 0/1 |
| L3 | PC (Home) | A3 | 1/1 |
| W1 | PDA | A1 | — |

Table 8 shows count values that have been updated at step S114. In this example, after an e-mail was sent to the delivery target person A according to the delivery address list prepared in the above-mentioned way, a confirmation was returned from PC (Home) 33 (mail address A3) ranked second in the delivery address list instead of PC (Office) 32 (mail address A2) at the top of the list. It means that for the personal condition (see Table 2), in fact information could reach the delivery target person A faster if a higher priority is given to the delivery requirement L3 than the delivery requirement T2 despite the target person's initial registration (i.e. the delivery requirement T2 (PC (office) 32) is given higher priority than the delivery requirement L3 (PC(Home) 33). In this case, the count value for the delivery requirement T2 becomes 0/1 (zero confirmation returned (received) for one mail delivery), and that for the delivery requirement L3 becomes 1/1 (one confirmation returned (received) for one mail delivery). In addition, no mail has been sent to PDA 31 since a confirmation was returned from PC (Home) 33 before sending one to PDA 31 ranked third in the delivery address list. The count value for the delivery requirement W1 therefore remains as it was.

TABLE 9

| Condition | Device | Address | Score |
|---|---|---|---|
| T1 | PDA | A1 | −1 |
| T2 | PC (Office) | A2 | −1 |
| T3 | PC (Home) | A3 | −1 |
| L1 | PDA | A1 | −2 |
| L2 | PC (Parents' Home) | A4 | −2 |
| L3 | PC (Home) | A3 | −2 |
| W1 | PDA | A1 | −3 |
| W2 | PC (Office) | A2 | −3 |
| W3 | PDA | A1 | −3 |

Table 9 shows scores that are stored in the score generation and storage portion 18 in the initial state. In this example, based on the priority list (see Table 1(d)) registered by the delivery target person A, a score −1 is given to entries relevant to time that has the highest priority, a score −2 to entries relevant to location of the second highest priority, and a score −3 is given to entries relevant to weather of the third highest priority, for each delivery requirement.

TABLE 10

| | | | Theoretical | | |
|---|---|---|---|---|---|
| Condition | Device | Address | Point | Count | Score |
| T2 | PC (Office) | A2 | 3 | 0/1 | 0 |
| L3 | PC (Home) | A3 | 2 | 1/1 | 2 |
| W1 | PDA | A1 | 1 | — | −3 |

Table 10 shows scores that are calculated at step 115. In this example, a new score is determined by multiplying a theoretical point for each delivery requirement by an updated count value. In this example, the score for the delivery requirement T2 for which no confirmation mail has been returned is 0, and the score for the delivery requirement L3 for which a confirmation mail has been returned is 2. No calculation is performed for the delivery requirement W1 and its score remains as it was since no mail has been sent for the requirement.

TABLE 11

| Condition | Device | Address | Theoretical Point |
|---|---|---|---|
| T2 | PC (Office) | A2 | 2 |
| L3 | PC (Home) | A3 | 3 |
| W1 | PDA | A1 | 1 |

TABLE 12

| Condition | Device | Address | Theoretical Point |
|---|---|---|---|
| T1 | PDA | A1 | 3 |
| T2 | PC (Office) | A2 | 2 |
| T3 | PC (Home) | A3 | 3 |
| L1 | PDA | A1 | 2 |
| L2 | PC (Parents' Home) | A4 | 2 |
| L3 | PC (Home) | A3 | 3 |
| W1 | PDA | A1 | 1 |
| W2 | PC (Office) | A2 | 1 |
| W3 | PDA | A1 | 1 |

Table 11 shows theoretical points modified at step 118 and Table 12 shows theoretical points that are updated and stored in the theoretical point generation and storage portion 19 through the modification. In this example, modification of theoretical points is performed such that theoretical points for delivery requirements whose score has increased are changed to 3, the highest point, and theoretical points for delivery requirements whose score has reduced is decreased by one. Therefore, the theoretical point for the delivery requirement T2 for which a mail has been sent but no reply has been returned decreases from 3 to 2, that for the delivery requirement L3 for which a mail has been sent and a reply has been returned increases from 2 to 3, and that for the delivery requirement W1 for which nothing has been done remains 1.

TABLE 13

| | |
|---|---|
| Time | 16:30 |
| Location | Tokyo |
| Weather | Others |

Table 13 shows personal condition for the delivery target person A that is obtained at step 102 after delivery of an e-mail from the e-mail delivery terminal 1a to the delivery target person A was accepted at step 101. As shown, the time is 16:30, the location where the target person A is expected to stay is Tokyo, and the weather is “other.”

TABLE 14

| | | | Theoretical |
|---|---|---|---|
| Condition | Device | Address | Point |
| T2 | PC (Office) | A2 | 2 |
| L3 | PC (Home) | A3 | 3 |
| W3 | PDA | A1 | 1 |

Table 14 shows theoretical points that are obtained at step 105. Unlike the above example, it can be seen that the delivery requirement L3 has a greater theoretical point than the delivery requirement T2. That is, a delivery address list will be prepared at step 107 that puts the delivery requirement L3 in the first place and the delivery requirement T2 in the second place.

By repeating such a process, it is possible to increase the possibility that information will reach the delivery target person A accurately, i.e. the probability that an e-mail can be sent preferentially to an e-mail receiving terminal with which the person can receive e-mails. Thus, in this embodiment, even if a theoretical delivery address list that is initially registered by the delivery target person A contains some mistake, the delivery address list can be optimized in accordance with actual utilization of devices. In addition, when records registered with the context database portion 13 or information provided as personal condition are little in amount for the purpose of protecting the target person A's privacy, the behavior pattern of the delivery target person A can be tracked and thus information can be communicated to him/her in an optimal and effective way. Moreover, while e-mails are sent sequentially from the top mail address in the delivery address list in this embodiment, unnecessary increase in traffic amount can be avoided since further e-mail delivery is stopped when a confirmation mail is returned from the target person.

Although this embodiment addresses e-mail delivery from the e-mail delivery terminal al to the delivery target person A, it is also possible to optimize a delivery address list for the delivery target person B and increase the possibility of delivering information to the person accurately using the same way. Similarly, this embodiment can be applied to a case where an e-mail is sent from any of other e-mail delivery terminals 1b to 1e to the target person A or B. In that case, the e-mail delivery terminals 1b to 1e can share theoretical points that have been obtained when the e-mail delivery terminal 1a sent e-mails so that information can be communicated to a target person more accurately.

Although the embodiment uses time/date, location and weather as entries to be initially set by the target person, this is not limitation, but more or less entries may be used. Examples of other possible entries include whether the target person is “at business” or “in his/her private time” and environments in which the target person can be placed. Examples of environments include a case where the person works at home when he/she learns from traffic information that the route to his/her office is congested or a case where he/she goes to a securities company when he/she learns from stock quote information that the price of a stock the person is in charge of has topped a given price.

Although e-mails are sent from the delivery server 10 in the embodiment, this is not limitation but a delivery address list may be generated upon accepting a request for an e-mail delivery and returned to any of the e-mail delivery terminals 1a to 1e (one that wants to send the e-mail). That is, the contacts of the delivery target person may be provided to the e-mail delivery terminal group 1. In such a case, a telephone number (of a fixed telephone or mobile phone) or a facsimile number may be provided as his/her contact other than an e-mail address. The contact might be an e-mail address, telephone number, or facsimile number of a neighbor of the delivery target person, for example.

The following will describe a result of simulation for verifying the effect of the process above.

In the simulation, the following preconditions were set.

1) The delivery target person has five e-mail receiving terminals (devices 0, 1, 2, 3 and 4);

2) The target person has made his/her priority list that orders the devices as 0→1→2→3→4; and

3) The probabilities that confirmation mails are returned from each device in use are set as below;

device 2: ½

device 0: ¼

device 3: 1/16

device 1: 1/256

device 4: 1/65536

Therefore, it is expected from the precondition 3) that the order 0→1→2→3→4 in the priority list set by the target person will shift to 2→0→3→1→4.

The simulation generated 500 random numbers between 0 and 4 that produce confirmations to be returned from each of the devices 0 to 4 with the above-mentioned probabilities. Some of the generated random numbers are shown in Table 15.

TABLE 15

| | Device number for which a |
|---|---|
| Round | confirmation returned |
| 1 | 2 |
| 2 | 2 |
| 3 | 0 |
| 4 | 2 |
| 5 | 2 |
| . | . |
| . | . |
| . | . |
| 23 | 2 |
| 24 | 2 |
| 25 | 3 |
| 26 | 2 |
| . | . |
| . | . |
| . | . |
| 496 | 0 |
| 497 | 2 |
| 498 | 0 |
| 499 | 0 |
| 500 | 2 |

Table 15 shows a state in which the first confirmation has been returned from device 2, the second also from device 2, and the third from device 0. As a result, total numbers of confirmations returned from each device were obtained as below;

device 0: 311

device 1: 152

device 2: 35

device 3: 2

device 4: 0

Table 16 shows entire result of the simulation. In the table, “No” indicates a device number from which the confirmation has been returned.

TABLE 16

| | | Device 0 | | Device 1 | | Device 2 | | Device 3 | | Device 4 | |
|---|---|---|---|---|---|---|---|---|---|---|---|
| Round | No | Count | Score | Count | Score | Count | Score | Count | Score | Count | Score |
| 1 | 2 | 0/1 | 0.000 | 0/1 | 0.000 | 1/1 | 2.000 | 0/0 | 0.000 | 0/0 | 0.000 |
| 2 | 2 | 0/1 | 0.000 | 0/1 | 0.000 | 2/2 | 4.000 | 0/0 | 0.000 | 0/0 | 0.000 |
| 3 | 0 | 1/2 | 2.000 | 0/1 | 0.000 | 2/3 | 2.667 | 0/0 | 0.000 | 0/0 | 0.000 |
| 4 | 2 | 1/2 | 2.000 | 0/1 | 0.000 | 3/4 | 3.000 | 0/0 | 0.000 | 0/0 | 0.000 |
| 5 | 2 | 1/2 | 2.000 | 0/1 | 0.000 | 4/5 | 3.200 | 0/0 | 0.000 | 0/0 | 0.000 |
| . | . | . | . | . | . | . | . | . | . | . | . |
| . | . | . | . | . | . | . | . | . | . | . | . |
| . | . | . | . | . | . | . | . | . | . | . | . |
| 498 | 0 | 151/200 | 2.265 | 2/3 | 0.667 | 310/496 | 2.500 | 35/40 | 1.750 | 0/0 | 0.000 |
| 499 | 0 | 152/201 | 2.269 | 2/3 | 0.667 | 310/497 | 2.495 | 35/40 | 1.750 | 0/0 | 0.000 |
| 500 | 2 | 152/201 | 2.269 | 2/3 | 0.667 | 311/498 | 2.498 | 35/40 | 1.750 | 0/0 | 0.000 |

Table 16 shows the following:

On the first round, the order of sending an e-mail is the initial value 0→1→2→3→4, which has been set by the delivery target person. After actually sending an e-mail, however, devices 0 and 1 returned no confirmation and device 2 returned a confirmation. Thus, the count value for the devices 0 and 1 becomes 0/1 and the score becomes 0.0. On the other hand, for the device 2, the count value becomes 1/1 and the score 2.0. For the devices 3 and 4, the count value remains 0/0 and the score is 0.0 since no e-mail has been sent to those devices.

On the second round, the order of sending an e-mail has become 2→0→1→3→4 according to the result of the first round. After an e-mail was actually sent, the device 2 returned a confirmation, which results in the count value 2/2 and the score 4.0 for the device 2. The count value remains 0/1 and the score also remains 0.0 for the devices 0 and 1 since no e-mail has yet been sent to those devices. Also, the count value and score of the devices 3 and 4 also remain the same since no e-mail has been sent to those devices either. On the third round, the order of sending an e-mail has become 2→0→1→3→4 in accordance with the result of the previous round. After an e-mail is actually sent, device 0 returned a confirmation, which results in the count value 1/2 and score 2.0 of the device 0. Meanwhile, the count value for the device 2 becomes 2/3 and its score drops to 2.667. The count value and score for the devices 1, 3, and 4 remain the same since no e-mail were sent to those devices.

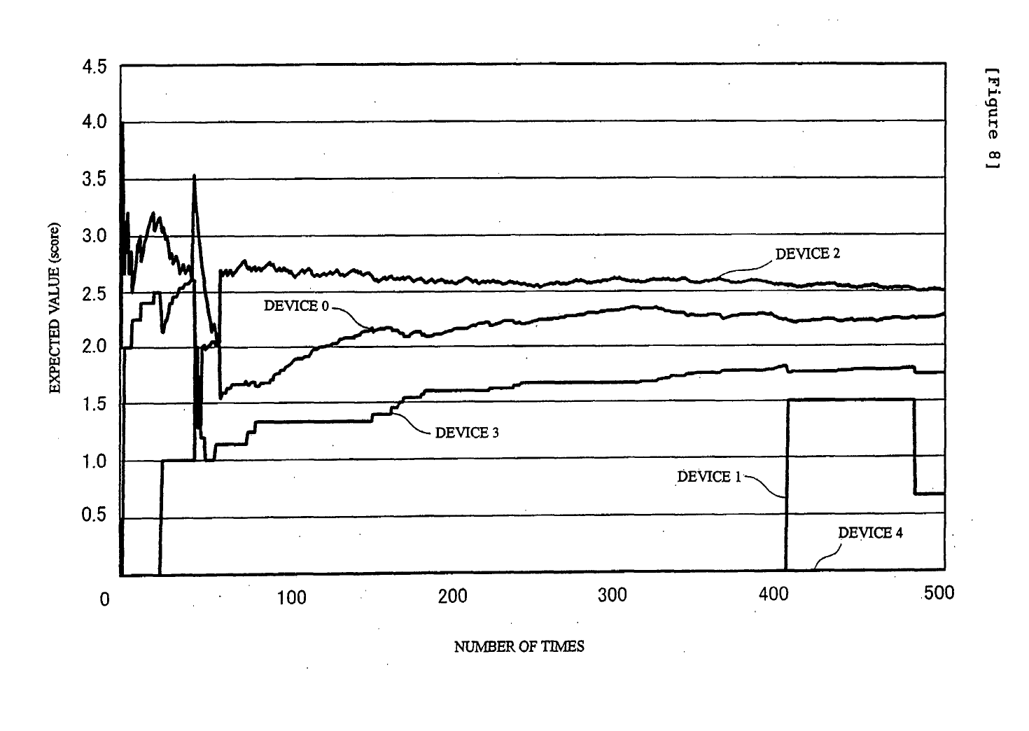

FIG. 8 is a graph illustrating the relationship between the number of attempts to send e-mails (the number of times) and scores that are thus obtained through the simulation. It can be seen that as the number of e-mail delivery increases, the order 0→1→2→3→4, which was set as the priority list set by the delivery target person approaches to 2→0→3→4, the order reflecting the actual situation.

As has been described, according to the invention, information can be communicated accurately to a target person having a plurality of mail addresses or contacts.

### Description of Symbols

1 . . . E-mail delivery terminal group

1a-1e . . . E-mail delivery terminals

10 . . . Delivery server

11 . . . Delivery request accepting portion

12 . . . Personal condition acquisition portion

13 . . . Context database portion

14 . . . Theoretical delivery address list generation portion

15 . . . Delivery address list generation portion

16a . . . Delivery portion

16b . . . Receiving portion

17 . . . Count storage portion

18 . . . Score generation and storage portion

19 . . . Theoretical value generation and storage portion

20 . . . Internet

30 . . . First e-mail receiving terminal group

31 . . . PDA

32 . . . PC (Office)

33 . . . PC (Home)

34 . . . PC (Parents)

40 . . . Second e-mail receiving terminal group

41 . . . PC (Home)

42 . . . WAP

1. An e-mail delivery device for sending an e-mail to a target person having a plurality of e-mail addresses, comprising:
storage means for storing a condition of the target person associated with said e-mail addresses;
prediction means for predicting the target person's condition when sending the e-mail to the target person;
ordering means for fetching a given number of e-mail addresses from said storage means and ordering the given number of fetched e-mail addresses on the basis of said predicted condition; and
delivery means for sending an e-mail sequentially to each of said given number of e-mail addresses by using said given number of ordered e-mail addresses.

2. The e-mail delivery device according to claim 1, wherein said prediction means obtains the target person's schedule and predicts said condition on the basis of the obtained schedule.

3. The e-mail delivery device according to claim 1, further comprising:
receiving means for receiving a receipt confirmation returned from one of said given number of e-mail addresses in response to the e-mail sent by said delivery means,
wherein said delivery means stops sending an e-mail when said receipt conformation has been received.

4. The e-mail delivery device according to claim 1, further comprising:
receiving means for receiving receipt confirmations returned from one of said given number of e-mail addresses in response to the e-mail sent by said delivery means,
wherein said ordering means modifies the order of said given number of e-mail addresses in the next ordering.

5. The e-mail delivery device according to claim 1, wherein said ordering means fetches an e-mail address from said storage means that matches said condition predicted by said prediction means.

6. An e-mail delivery device for sending an e-mail to a target person having a plurality of e-mail addresses, comprising:
storage means for storing records of delivery requirements of the target person associated with e-mail addresses at which the target person desires to receive an e-mail;
condition acquisition means for acquiring a personal condition in which the target person is supposed to be in when sending the e-mail to the target person;
delivery list generation means for acquiring records matching said condition acquired by said condition acquisition means from said storage means and generating a delivery requirement list;
theoretical value generation means for generating a theoretical value related to ease of arrival of the e-mail at the target person;
delivery priority list generation means for generating a delivery priority list by ordering the e-mail addresses in said delivery requirement list generated by said delivery list generation means on the basis of the theoretical value generated by said theoretical value generation means; and
delivery means for sending the e-mail to the e-mail addresses in the order of descending priorities thereof on the basis of said delivery priority list generated by said delivery priority list generation means.

7. The e-mail delivery device according to claim 6, further comprising:
receiving means for receiving a receipt confirmation for the e-mail sent by the delivery means,
wherein said theoretical value generation means modifies said theoretical value on the basis of said receipt confirmation received by said receiving means.

8. The e-mail delivery device according to claim 7, further comprising:
count storage means for storing said delivery requirements associated with the number of attempts to send e-mails by said delivery means and the number of times receipt confirmations have been received by said receiving means; and
expected value generation means for generating an expected value corresponding to each delivery requirement on the basis of a count value stored in said count storage means,
wherein said theoretical value generation means modifies said theoretical values on the basis of said expected values generated by said expected value generation means.

9. The e-mail delivery device according to claim 6, further comprising:
initial priority storage means for storing a list of priorities of said delivery requirements preset by a target person,
wherein said theoretical value generation means determines the initial theoretical values on the basis of the initial priority list obtained from said initial priority storage means.

10. A contact point guiding device for guiding a contacting person to a contact point when contacting a target person having a plurality of contact points, comprising:
acquisition means for acquiring correspondence between a target person's condition and said contact points;
prediction means for predicting the condition of the target person when contacting the target person; and
ordering means for acquiring a given number of contact points by using said acquisition means and ordering the given number of acquired contact points on the basis of said predicted condition.

11. The contact point guiding device according to claim 10, wherein said contact point acquired by said acquisition means comprises at least one of an e-mail address, a telephone number, and a facsimile number.

12. The contact point guiding device according to claim 10, wherein said ordering means makes the next ordering that reflects the result of contact performed in accordance with said ordering.

13. An e-mail delivery method of sending an e-mail to a specific e-mail address from a storage device storing a plurality of e-mail addresses for a given target person, comprising the steps of:
predicting a condition of the target person when sending the e-mail to the target person;
fetching said plurality of e-mail addresses from said storage device and ordering the plurality of e-mail addresses on the basis of said predicted condition; and
sending the e-mail sequentially on the basis of said ordering.

14. A program product for enabling a computer to send an e-mail from a storage device storing a plurality of e-mail addresses for a given target person to a specific e-mail address for achieving the functions of:
predicting a target person's condition when sending the e-mail to the target person;
fetching said plurality of e-mail addresses from said storage device and ordering the plurality of e-mail addresses on the basis of said predicted condition; and
sending the e-mail sequentially on the basis of said ordering.
